(19) United States
(12) Patent Application Publication
(10) Pub. No.: US 2003/0231641 A1
(43) Pub. Date: Dec. 18, 2003

(54) Home gateway system having display controller

(75) Inventor: Jae-Kwan Ryoo, Suwon-city (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/373,655

(22) Filed: Feb. 26, 2003

(30) Foreign Application Priority Data
Mar. 7, 2002 (KR) 2002-12230

(51) Int. Cl. H04L 12/28

(52) U.S. Cl. 370/401; 370/420

(57) ABSTRACT

A home gateway system having a display device therein. The home gateway system is connected through plural high-speed home buses of plural lines to plural home network devices, for converting data and thus enabling data communication among an external communication network and the plural home network devices. The home gateway system includes a memory, and a control unit for causing data processed at a display device of a home network device to be respectively categorized into user classifications and stored in the memory, and causing the stored data to be displayed at a display device of another home network device that is intended by a user. As a result, the user is enabled to use data processed at a display device of one home network device at a display device of another home network device of the same home network.

### BACKGROUND OF THE INVENTION

1. Field of the Invention

The present invention relates to a home gateway system, and more particularly, to a home network system having a display controller that enables a user to use the data processed in a display of a certain home network device in another display device of another home network device connected in the same home network.

2. Description of the Prior Art

Generally, a gateway system is positioned between two communication networks that use different data communication protocols to convert data of each network into suitable data for the other ones. Among the gateway systems, a home gateway system performs network matching with respect to home network at home and external communication network.

FIG. 1 is a block diagram of a conventional home gateway system.

Referring to FIG. 1, a conventional home gateway system 20 connects an external communication network 10 to a home network 60, and interfacing communication between the external communication network 10 and the home network 50.

The home network 50 consists of one, or plural home buses, and each of the home buses is connected with home network devices 30a-30n, 40a-40n of various types.

In addition to the public switched telephone network (PSTN), the communication networks of various protocols such as data network, cable network, are connectible to the home gateway system 20 as the external communication network 10. Likewise, in addition to the home network 50, various types of home buses such as universal serial bus (USB), IEEE 1394, home phone line network alliance (HPNA), WLAN, wireless LAN and Bluetooth can also be connected to the home gateway system 20.

Typical examples of the home network devices 30a-30n, 40a-40n that are connected to the home bus are telephones and computer, and with the recent diversification of multimedia services, there has been addition of home network devices with the various home appliances such as internet refrigerator, digital TV, settop box that are connectible to the external communication network such as ultra-high speed communication network.

The problem is that, since there is no separate monitor device provided for the conventional home gateway system for the functions such as system control and maintenance, the user always needed to connect the home network device such as personal computer to the home bus for the system control or maintenance.

Accordingly, for moving from one position to another in home network, or even for rather simple functions such as data display or environment set-up, the user needed to connect the device such as personal computer to the home bus, and operate the whole home gateway system.

With the recent diversification of home network devices, there has also been an increasing demand for new functions in addition to simple data display function of the display device of the home network device, and accordingly, efficient use of home gateway system is in great attention.

### SUMMARY OF THE INVENTION

Accordingly, it is a first object of the present invention to provide a home gateway system having a display control device which, in a home network consisting of plural home network devices connected thereto, enables the use of data which is processed at a display device of one home network device, in a display device of another home network device in the same home network.

It is a second object of the present invention to provide a home gateway system having a display device, which can save unnecessary power consumption because it is not the entire home gateway system but a certain necessary part that is operated to drive the display device of the home network device used by the user.

In order to accomplish the above objects, in a home gateway system connected through plural high-speed home buses of plural lines to plural home network devices, for converting data and thus enabling data communication among an external communication network and the plural home network devices, the home gateway system according to the present invention includes a memory, and a control unit for causing data processed at a display device of a home network device to be respectively categorized into user classifications and stored in the memory, and causing the stored data to be displayed at a display device of another home network device that is intended by a user.

According to the present invention, further provided are a monitor device for viewing the data stored in the memory, and inputting data to the memory, a signal detection unit for determining whether or not the home network devices are connected to the home buses, and outputting a resultant detection signal, and a display control unit for causing the data stored in the memory to be displayed at a display device of a home network device that is determined to be connected to the home buses according to the detection signal output from the signal detection unit. As a result, since only a necessary part for driving the display device is operated, power wastage can be prevented.

Meanwhile, the present invention also provides a display control method for a home gateway system. In a home gateway system being connected through plural high-speed home buses of plural lines to plural home network devices, for converting data and thus enabling data communication among an external communication network and the plural home network devices, the display control method according to the present invention includes the steps of storing data that is processed through a display device of a home network device, determining whether there is a data display request by a user from another home network device, and if determining that there is the data display request made by the user, displaying the stored data at a display device of a home network device that is intended by the user.

Further provided are the steps of determining whether or not the home network devices are connected to the home buses, and if determining the home network devices to be connected to the home buses, causing the stored data to be displayed at the display devices of the home network devices. Again, since only the necessary parts for driving the display device are operated, power wastage can be prevented.

### BRIEF DESCRIPTION OF THE DRAWINGS

The above objects and other features of the present invention will become more apparent by describing in detail a preferred embodiment thereof with reference to the attached drawings, in which:

FIG. 1 is a block diagram of a conventional home gateway system;

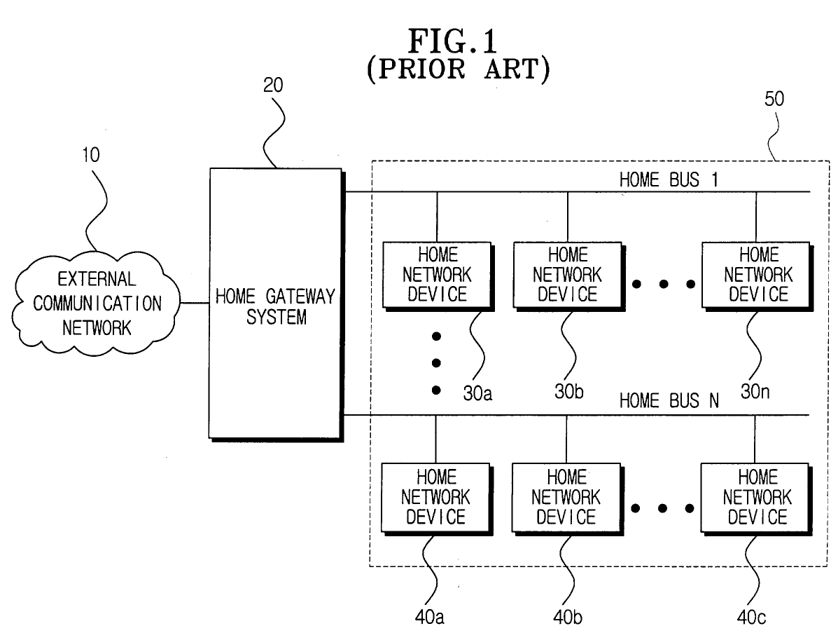

FIG. 2 is a block diagram of a home gateway system according to the present invention;

FIG. 3 is a flowchart illustrating a display control method of a home gateway system according to a preferred embodiment of the present invention; and

FIG. 4 is a flowchart illustrating a display control method of a home gateway system according to another preferred embodiment of the present invention.

### DETAILED DESCRIPTION OF THE PREFERRED EMBODIMENT

Hereinafter, the present invention will be described in detail with reference to the accompanying drawings.

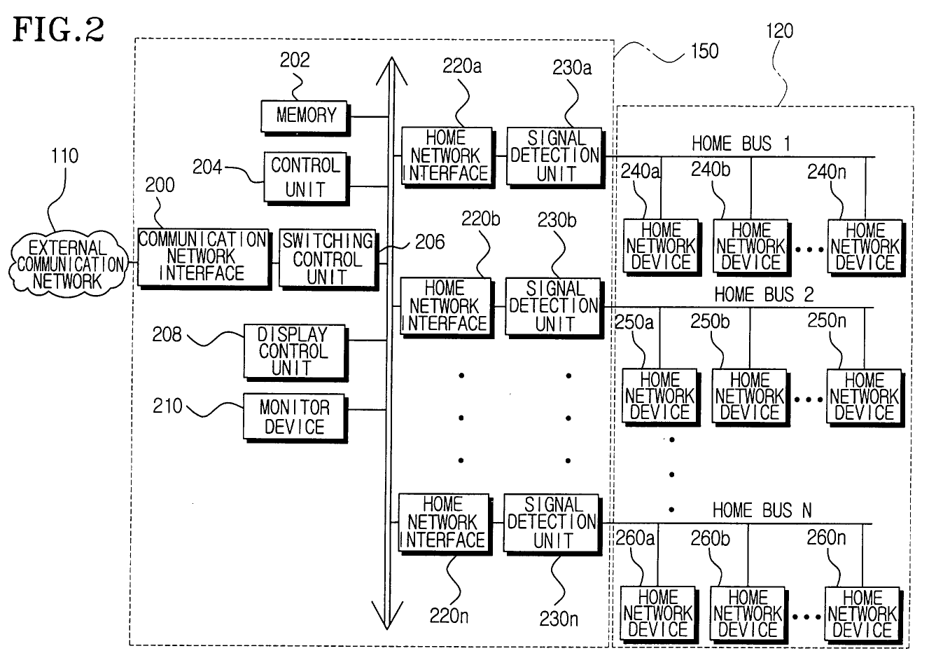

FIG. 2 is a block diagram of a home gateway system according to the present invention.

Plural home network interfaces 220a-220n are connected to a communication network interface 200 through a switching control unit 206, with each of the home network interfaces 220a-220n interfacing with home buses of various protocols through signal detection units 230a-230n. Various home network devices 240a-240n, 250a-250n, 260a-260n are connected to the home buses.

Referring to FIG. 2, the communication network interface 200 converts data of a predetermined protocol of an external communication network 110 into Ethernet packet data for switching transmission at the switching control unit 206, and then transmits the Ethernet packet data to the home network interfaces 220a-220n through the switching control unit 206. The communication network interface 200 also converts the Ethernet packet data applied from the home network interfaces 220a-220n through the switching control unit 206 into data suitable for the predetermined protocol of the corresponding external communication network 110, and then transmits the converted data to the external communication network 100.

The plurality of home network interfaces 220a-220n convert data so that the home network devices 240a-240n, 250a-250n, 260a-260n can communicate with each other. More specifically, the home network interfaces 220a-220n convert data from respective home buses of various protocols such as IEEE1394, home phone line network alliance (HPNA), universal serial bus (USB), LAN, wireless LAN and Bluetooth into Ethernet packet data for switching at the switching control unit 206. The Ethernet packet data are transmitted to the communication network interface 200 through the switching control unit 206, being converted at the switching control unit 206 into data of the protocol of corresponding home network 150, and transmitted to the home network 150.

The switching control unit 206 switches the Ethernet packet data being transmitted between the communication network interface 200 and the plural home network interfaces 220a-220n, and transmits the data to the corresponding interface.

A memory 202 may be used for storages of programs or data. Additionally, a hard disk may be connected to the memory 202 to store large volume of data.

A control unit 204 is provided to control overall operation of the system, and the signal detection units 230a-230n detect whether or not the home network devices 240a-240n, 250a-250n, 260a-260n are connected to the home buses connected to the home network interfaces 220a-220n, and send out detection signal to a display control unit 208.

According to the detection signal output from the signal detection units 230a-230n, the display control unit 208 determines whether the home network devices 240a-240n, 250a-250n, 260a-260n are connected or not, and accordingly controls so that the only the home network interfaces 220a-220n that interface with the home buses connected with the home network devices 240a-240n, 250a-250n, 260a-260n can be driven. Accordingly, only the corresponding home buses can be operated. There may be provided a monitor device 210 for viewing of the data stored in the memory 202 and inputting of data.

In the construction as described above, data may be input or processed by a user at a display device of one of the home network devices 240a-240n, 250a-250n, 260a-260n that are connected to the home buses, and the data after input or processing is categorized into respective IDs of corresponding home network devices and stored in the memory 202 under control of the control unit 204.

Once the data is stored in the memory 202, the user who wants to use the stored data at the display device of another home network device 240a-240n, 250a-250n, 260a-260n may have the data displayed at the display device of another home network device 240a-240n, 250a-250n, 260a-260n by using user ID and/or home network ID.

User may view desired data through the monitor device 210, and the data input or processed at the monitor device 210 can also be used just like the data that is processed or input in the display devices of other home network devices 240a-240n, 250a-250n, 260a-260n.

Meanwhile, the signal detection units 230a-230n detect whether the home network devices 240a-240n, 250a-250n, 260a-260n are connected to the respective home buses or not, and output detections signal to the display control unit 208. According to the detection signal as input, the display control unit 208 determines whether the home network devices 240a-240n, 250a-250n, 260a-260n are connected or not, and causes desired data to be displayed on the display device of corresponding home network devices 240a-240n, 250a-250n, 260a-260n. The display control unit 208 may control so that system can be operated to a minimum extent by driving only the home network interfaces 220a-220n to which the home network devices 240a-240n, 250a-250n, 260a-260n are connected.

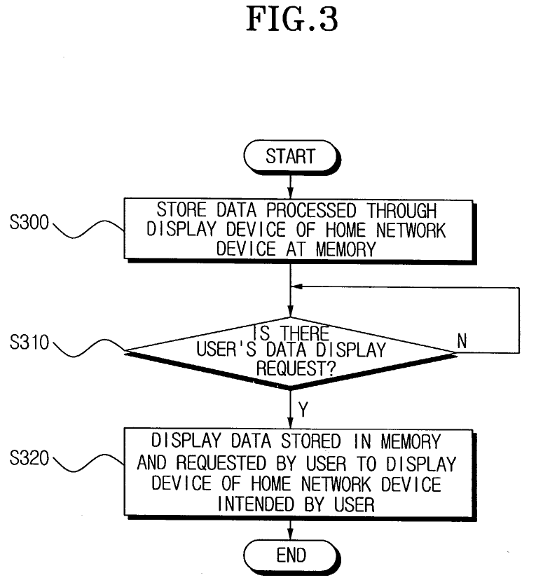

FIG. 3 is a flowchart illustrating a control method of a home gateway system according to one preferred embodiment of the present invention.

Referring to FIG. 3, first, the user inputs or processes data through a display device of the home network devices 240a-240n, 250a-250n, 260a-260n, and the data as input, or processed is stored in the memory 202 in operation S300.

Next, the control unit 204 in operation S310 determines whether the user wants the data previously processed at the other home network devices 240a-240n, 250a-250n, 260a-260n of the home network to be displayed or not.

If the user wants data to be displayed, the desired data is output to the display device of the home network device 240a-240n, 250a-250n, 260a-260n that is intended by the user.

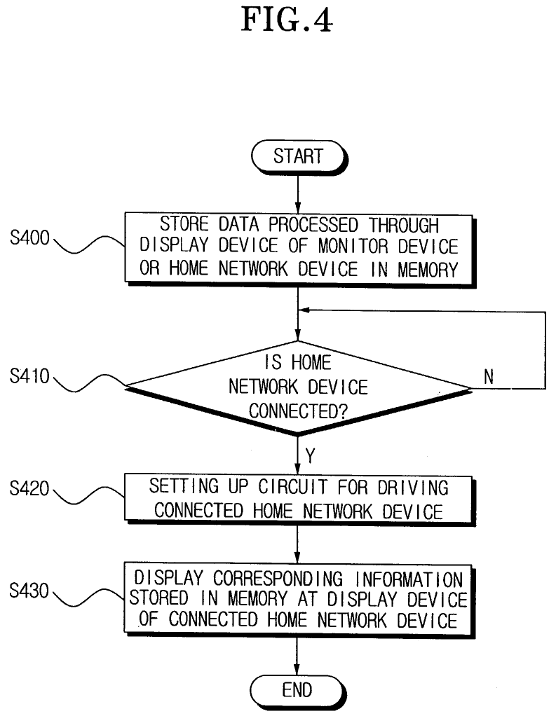

FIG. 4 is a flowchart illustrating a display control method of a home gateway system according to another preferred embodiment of the present invention.

Referring to the flowchart of FIG. 4, the user in operation S400 stores in the memory 202 the data that is processed through either the monitor device 210 or through the display devices of the home network devices 240a-240n, 250a-250n, 260a-260n.

Next, it is determined in operation S410 based on the signal output from the signal detection units 230a-230n whether the home network devices 240a-250n, 250a-250n, 260a-260n are connected or not. If determining the home network devices 240a-250n, 250a-250n, 260a-260n to be connected, a necessary circuit for data output is set up in operation S420, such as driving the home network interfaces 220a-220n of the connected home network devices 240a-240n, 250a-250n, 260a-260n.

As the circuit is set up, corresponding data stored in the memory 202 is output and thus displayed on the display device of the home network devices 240a-240n, 250a-250n, 260a-260n in operation S430. Accordingly, without having to drive entire system, the display devices of the home network devices 240a-240n, 250a-250n, 260a-260n can be controlled.

According to the present invention, data is processed at a display device of a home network device that is connected to a certain home bus, and then stored, and then whenever user wishes, the stored data can be used in the display device of other home network devices of the same network.

As described above, whether the home network devices are connected or not is determined based on the signal from the signal detection unit, and only some parts that are needed to drive a connected home network device can be operated according to the determination. As a result, since there is no need to drive the entire system, power wastage can be prevented, and system operation time can be reduced.

Although a few preferred embodiments of the present invention has been described, it will be understood by those skilled in the art that the present invention should not be limited to the described preferred embodiments, but various changes and modifications can be made within the spirit and scope of the present invention as defined by the appended claims.

What is claimed is:

1. A home gateway system connected through plural high-speed home buses of plural lines to plural home network devices, for converting data and thus enabling data communication among an external communication network and the plural home network devices, the home gateway system comprising:
a memory; and
a control unit for causing data processed at a display device of a home network device to be respectively categorized into user classifications and stored in the memory, and causing the stored data to be displayed at a display device of another home network device that is intended by a user.

2. The home gateway system of claim 1, further comprising a monitor device for viewing the data stored in the memory, and inputting data to the memory.

3. The home gateway system of claim 1, further comprising:
a signal detection unit for determining whether or not the home network devices are connected to the home buses, and outputting a resultant detection signal; and
a display control unit for causing the data stored in the memory to be displayed at a display device of a home network device that is determined to be connected to the home buses according to the detection signal output from the signal detection unit.

4. A display control method of a home gateway system connected through plural high-speed home buses of plural lines to plural home network devices, for converting data and thus enabling data communication among an external communication network and the plural home network devices, the display control method comprising the steps of:
storing data that is processed through a display device of a home network device;
determining whether there is a data display request by a user from another home network device; and
if determining that there is the data display request made by the user, displaying the stored data at a display device of a home network device that is intended by the user.

5. The display control method of claim 4, further comprising the steps of:
determining whether or not the home network devices are connected to the home buses; and
if determining the home network devices to be connected to the home buses, causing the stored data to be displayed at the display devices of the home network devices.
